(19) United States
(12) Patent Application Publication
(10) Pub. No.: US 2024/0227562 A1
(43) Pub. Date: Jul. 11, 2024

(54) IN-VEHICLE INFOTAINMENT SYSTEM

(71) Applicants: Hyundai Motor Company, Seoul (KR); Kia Corporation, Seoul (KR)

(72) Inventors: Ryung Hwa Rhee, Seoul (KR); Eun Aee Ko, Seoul (KR); Young Kwang Cho, Seoul (KR); Ik Jae Kwon, Seoul (KR); Jin Young Park, Gwangmyeong-Si (KR)

(21) Appl. No.: 18/526,219

(22) Filed: Dec. 1, 2023

(30) Foreign Application Priority Data
Jan. 11, 2023 (KR) 10-2023-0004243

(51) Int. Cl. B60K 35/80; B60K 35/22; B60K 35/28

(52) U.S. Cl. CPC B60K 35/80; B60K 35/22; B60K 35/28; B60K 2360/119; B60K 2360/164; B60K 2360/166

(57) ABSTRACT

The present disclosure provides an in-vehicle infotainment system of a vehicle. The system includes a display device, storage, and a controller. The display device includes a first region, a second region, and a third region. The storage is configured to store a first information element, a second information element, and a third information element. The controller is configured to control the display device to display the first information element in the first region, the second information element in the second region, the third information element in the third region. The controller is further configured to control, based on an additional information element being displayed in the third region, the display device to display, in the first region, the first information element and the third information element.

### CROSS-REFERENCE TO RELATED APPLICATION

The present application claims priority to Korean Patent Application No. 10-2023-0004243, filed on Jan. 11, 2023, the entire contents of which is incorporated herein by reference in its entirety.

### TECHNICAL FIELD

The present disclosure relates to an in-vehicle infotainment system.

### BACKGROUND

In recent years, vehicles have adopted a wide-format display cluster that integrates a navigation display with a vehicle cluster to display user convenience and various contents.

While only a limited number of information elements may be exposed in a scheme in which the cluster and the navigation display are separated, the wide display may also provide safety functions such as advanced infotainment systems and around-view monitors that provide various information elements, and thus, the wide display has recently been introduced into many vehicles.

The cluster device for the vehicle using the wide display is configured to produce a user interface (UI) to form a large region to be touched in order to facilitate touch manipulation by causing a problem such as an accident occurrence rate caused by only forward attention compared to a method of operating with a physical button when a region to be touched is displayed to be small in size during operation of an overall air conditioning system, an audio system, or a navigation system, e.g., when the air conditioning system, the audio system, or the navigation system is operated by being displayed like a button on the display.

In this case, when a menu for controlling another function is exposed on a region where a position information and a path information of the host vehicle are displayed through the navigation system, the menu is exposed and the position information and the path information of the host vehicle temporarily disappear, and thus route guidance cannot be continued.

The above-described background technology is only for enhancing understanding of the background of the present disclosure, and it should not be accepted that a person with general knowledge corresponds to the prior art as already known.

### BRIEF SUMMARY

The present disclosure provides a new type cluster system for a vehicle, which can improve visibility and convenience of touch by displaying a different screen information element (e.g., a menu) on the entire third region in a state where the self-vehicle location information element on the navigation displayed on the third region is displayed like a driving information element of the vehicle displayed on the first region when the different screen information element is displayed on the third region, and the self-vehicle location information element has not disappeared.

According to one or more example embodiments of the present disclosure, an in-vehicle infotainment system of a vehicle may include: a display device including a first region, a second region, and a third region; storage configured to store a first information element, a second information element, and a third information element; and a controller configured to control the display device to display: the first information element in the first region, the second information element in the second region, the third information element in the third region; and control, based on an additional information element being displayed in the third region, the display device to display, in the first region, the first information element and the third information element.

The first information element may include a driving information element associated with the vehicle. The second information element may include a user-selected information element. The third information element may include a navigation information element.

The driving information element may indicate at least one of a vehicle speed, an engine speed, or fuel efficiency.

The user-selected information element may indicate at least one of a picture, a current date, a current time, or an external temperature.

The navigation information element may include a navigation map being displayed across the first region, the second region, and the third region.

The navigation information element may further include a vehicle location information element indicating a current location of the vehicle. The controller may be further configured to control the display device to display, in the third region and based on the additional information element being displayed in the third region, the navigation map, the vehicle location information element, and path information element.

The additional information element may include at least one of an application menu, a display setting menu, or a navigation settings menu.

The first region, the second region, and the third region may be integrally formed on a screen of the display device.

The controller may be further configured to control the display device to display a wide-format screen spanning the first region, the second region, and the third region.

The controller may be further configured to control the display device to display a navigation map in a background of the first region, the second region, and the third region. The third information element may include an icon indicating a location of the vehicle on the navigation map.

According to one or more example embodiments of the present disclosure, a method may include: displaying, via a display device of an infotainment system in a vehicle: a first information element in a first region of the display device, a second information element in a second region of the display device, and a third information element in a third region of the display device; receiving a command for displaying an additional information element in the third region; and displaying, based on the receiving of the command: the first information element and the third information element in the first region, and the additional information element in the third region.

The first information element may include a driving information element associated with the vehicle. The second information element may include a user-selected information element. The the third information element may include a navigation information element.

The driving information element may indicate at least one of a vehicle speed, an engine speed, or fuel efficiency.

The user-selected information element may indicate at least one of a picture, a current date, a current time, or an external temperature.

The navigation information element may include a navigation map being displayed across the first region, the second region, and the third region.

The navigation information element may further include a vehicle position information element indicating a current location of the vehicle. The method may further include displaying, via the display device and in the third region and based on the additional information element being displayed in the third region, the navigation map, the vehicle position information element, and path information element.

The additional information element may include at least one of an application menu, a display setting menu, and a navigation settings menu.

The method may further include displaying, via the display device, a wide-format screen spanning the first region, the second region, and the third region.

The method may further include displaying, via the display device, a navigation map in a background of the first region, the second region, and the third region. The third information element may include an icon indicating a location of the vehicle on the navigation map.

Even when other information element is displayed in the third region, the host vehicle location information element is moved to and displayed in the first region so that the other information element can be displayed in the entire third region, thereby improving visibility of a driver when another information element is displayed, thereby achieving convenience in operation and preventing an accident caused by negligence of the driver while driving.

The effects obtainable from the present disclosure are not limited to the above-mentioned effects, and other effects not mentioned will be clearly understood by those skilled in the art from the following description.

### BRIEF DESCRIPTION OF DRAWINGS

FIG. 1 is a block drawing of an in-vehicle infotainment system according to an embodiment of the present disclosure.

FIG. 2 is a drawing illustrating a state in which a navigation information element is displayed in the third region on a display unit of an in-vehicle infotainment system according to an embodiment of the present disclosure.

FIG. 3 is a drawing illustrating a state in which another information element is displayed in the third region in a display unit of an in-vehicle infotainment system according to an embodiment of the present disclosure.

FIG. 4 is a flowchart illustrating a process of displaying a navigation information element in the first region when another information element is displayed in the third region in an in-vehicle infotainment system according to an embodiment of the present disclosure.

### DETAILED DESCRIPTION

The present disclosure may be modified in various ways and have various embodiments, and specific embodiments will be illustrated and described in the drawings. However, this is not intended to limit the present disclosure to specific embodiments, and it should be understood that the present disclosure includes all modifications, equivalents, and replacements included on the idea and technical scope of the present disclosure.

Terms including ordinals such as “first”, “second”, etc. may be used to describe various elements, but the elements are not limited by the terms. The terms are used only for the purpose of distinguishing one element from another component.

The term “and/or” may be used to include any combination of a plurality of items to be included. For example, “A and/or B” includes all three cases such as “A”, “B”, and “A and B”.

When it is stated that an element is “connected” or “linked” to another element, it should be understood that the element may be directly connected or linked to the other element, but another element may exist in between. On the other hand, when it is mentioned that an element is “directly connected” or “directly linked” to another element, it should be understood that another element does not exist in between.

In the description of embodiments, it will be understood that a layer (film), region, pattern or structure is formed “on” or “under” another layer (film), region, pad or pattern, either directly or through intervening layers. The reference to “up/up” or “down/down” is based on the parent learning shown in the drawings for convenience of explanation, and is used to show the relative positional relationship between the elements for convenience of explanation, and should not be understood as limiting the actual positions of the elements. For example, unless otherwise stated or A is positioned above B according to the property of A or B, “B” is merely showing that B is shown above A in the drawings, and B may be positioned below A or B and A may be laterally disposed in the actual product or the like.

Also, the size and width of each layer (film), region, pattern, or structure shown in drawings may be altered for convenience and accuracy of an explanation, and does not completely reflect the actual size.

The terms used in the present application are solely used to for explaining the specific embodiments, and is not intended limit the present disclosure thereof. A singular expression includes a plural expression unless there is a clear exception in the context. In the present application, it should be understood that the term “include” or “have” is intended to designate the presence of a feature, a number, a step, an operation, a component, a part, or a combination thereof described in the specification, but does not exclude the possibility of the presence or addition of one or more other features, numbers, steps, operations, components, parts, or combinations thereof in advance.

Unless defined otherwise, all terms used herein, including technical or scientific terms, have the same meaning as that generally understood by those skilled in the art to which the present disclosure pertains. It will be understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, an embodiment of the present disclosure will be described in detail with reference to the accompanying drawings, and elements that are same or corresponding regardless of the symbols of the drawing will be assigned the same reference numbers and overlapping explanations herein will be omitted.

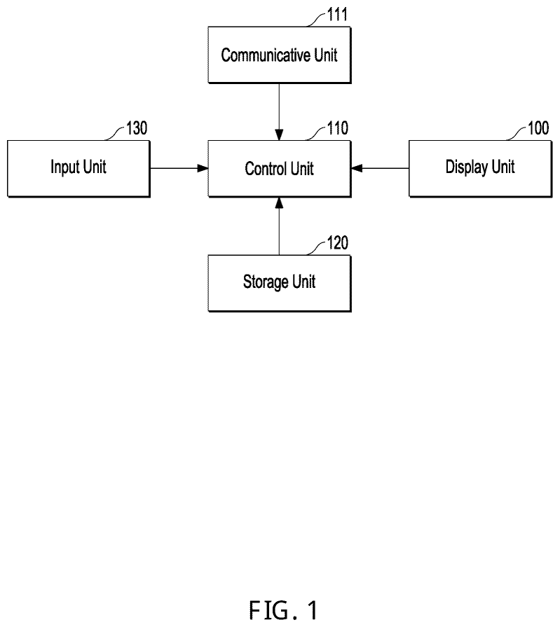

According to an embodiment of the present disclosure as shown in FIG. 1, an infotainment entertainment system embedded in a vehicle comprises a display unit 100 (e.g., a display device), a storage 120, a controller 110, and an input unit 130 (e.g., an input interface).

The display unit 100 may be a horizontally, long display in which a digital cluster provided in front of a steering wheel of a vehicle and a central display provided in the center of a vehicle dashboard are integrated with each other. The display unit 100 may display the infotainment.

The infotainment is an integrated concept of information that is necessary information elements such as driving and route guidance, and entertainment, which signify various entertainment and human-friendly functions, and various types of information elements displayed on the display unit 100 are becoming more diverse due to the combination of not only vehicle navigation, audio, video, and internet, but also the popularization of smart phones and tablet PCs and the development of information element technology (IT).

The embodiment is limited to the first information element to the third information element displayed on the display, but is not limited to a specific information element displayed on the infotainment screen. The first to third information elements will be described later.

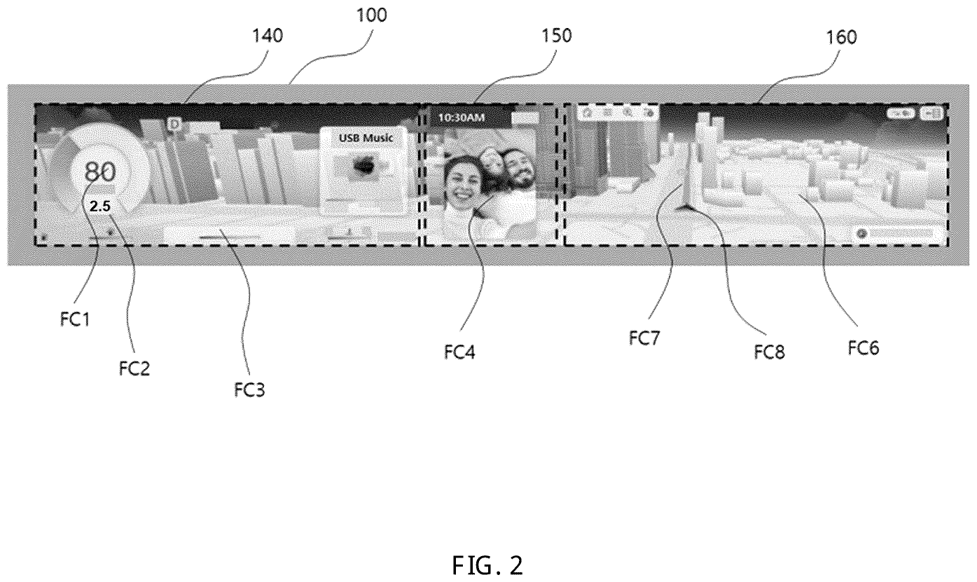

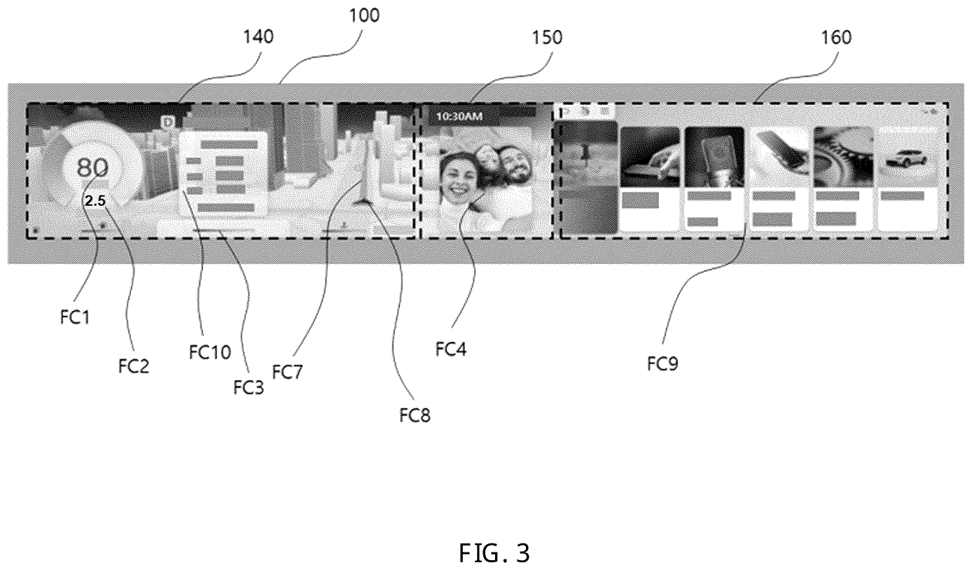

As shown in FIGS. 2 and 3, the display unit 100 includes the first region 140 in which the first information element is displayed, the second region 150 in which the second information element is displayed, and the third information element in which the third region 160 is displayed.

The first region 140 to the third region 160 of the display unit 100 are not separate displays, and a part where an information element is displayed on one, integrally-formed display unit 100 is three regions in the present embodiment. The display unit may be configured to provide one wide (e.g., wide-format) integral screen spanning from a front left corner of a driver's seat compartment to a front right corner of a front-passenger's seat compartment (or for vehicles with a steering column on the right side, spanning from a front left corner of a passenger's seat compartment to a front right corner of a driver's seat compartment).

The storage unit 120 stores data for displaying the first information element to the third information element. The storage unit 120 may be an auxiliary memory device. The auxiliary memory device may be at least one of a solid-state drive (SSD) and a hard disk drive (HDD).

The controller 110 controls the first information element to the third information element to be displayed on the display 100 through data stored in the storage 120. The controller 110 includes a central processing unit (CPU) and a main memory device (RAM).

When another information element is displayed in the third region 160 by the operation of the driver, the controller 110 controls the third information element displayed in the third region 160 to be displayed together with the first information element displayed in the first region 140.

The input unit 130 receives a command for manipulating an information element displayed on the display unit 100 from the driver. In the present embodiment, the input unit 130 may be a touch screen device provided in the display unit 100. According to an embodiment, the input unit may be a dial device provided in a center console and may be an operation button provided on the dashboard.

The first information element includes a driving information element of the vehicle. Referring to FIGS. 2 and 3, at least one of the speed FC1, the engine speed FC2, and the fuel efficiency information FC3 of the vehicle is displayed on the first region 140 of the display unit 100. The driving information element of the vehicle may be input through the ECU of the vehicle, but the present disclosure is not limited thereto, and any device may be used as long as it can receive the speed of the vehicle, the engine speed, and the fuel efficiency among the components of the vehicle. In the case of the electric vehicle, a vehicle speed, the amount of power used, a battery capacity, and the like may be received.

The second information element includes an information element set by the driver. The information element set by the driver may include at least one of a picture image FC4, a current time, and a date FC5, an external temperature (e.g., atmospheric temperature), weather conditions, etc. As illustrated in FIG. 2, the driver may set the second region 150 of the display unit 100 to display such as a photo image FC4. The setting method may be an image file stored in the storage unit 120 or an image file downloaded through wireless Internet. When downloading through wireless Internet, the controller 110 may further include a communication unit 11. The communication unit 111 may include at least an LTE, a 5G, or a Wi-Fi module. The controller 110 may store a picture image FC4 and the like received through the communicator 111 in the storage 120.

The second information element displayed in the second region 150 may not disappear from the display unit 100 or be covered by another screen and may be displayed at all times when there is no handling by the driver.

The third information element includes a navigation information element FC6 as shown in FIGS. 2 and 3. The navigation information element FC6 includes a 3D map in the form of a bird's eye view as a navigation map, and the 3D map is displayed over all of the first to third regions 140, 150 and 160 as shown in FIGS. 2 and 3. Also, a part of the map may be displayed on the entire third region 160. The 3D map may be displayed as a background on the entire display unit 100 as illustrated in FIGS. 2 and 3, and the 3D map may be updated to be displayed on the display unit 100 as the vehicle travels.

The navigation information further includes vehicle location information FC8 and path information FC7. The host vehicle location information FC8 and the path information FC7 may be displayed on the third region 160. Also, the vehicle location information FC8 may include an icon indicating a current location of the vehicle as shown in FIG. 2.

When the other information elements are displayed as shown in FIG. 3 while being displayed on the third region 160 as shown in FIG. 1, the vehicle position information FC8 may be displayed on the first region 140 in a state in which the region of the 3D map is reduced so that the vehicle position information elements and the path information elements are seen to be moved to the first region 140 when the 3D map of the region where the displayed vehicle position information FC8 and the path information FC7 of the third region 160 are displayed on the first region 140, and the other information elements are displayed on the third region 160. When the 3D map of the region where the vehicle position information FC8 and the path information FC7 are displayed is moved to the first region 140 and displayed, the position of the first information element displayed in the first region 140 may be newly aligned while being changed.

The other information element includes a menu information element FC9, and the menu information element FC9 includes at least one of destination, phone projection, voice recording, phone connecting (Bluetooth Wi-Fi connection), setup, and 3D map setup as shown in FIG. 10. The display of the menu information element FC9 may be displayed in the third region 160 when a menu activation button in the third region 160 illustrated in FIG. 7 is touched or a button provided on the vehicle center console or the dashboard is pressed. As shown in FIG. 2, the menu information element FC9 is in the third region may be displayed on the entire screen 160.

Accordingly, when the driver touches the menu information element FC9 while driving to manipulate the functions of the vehicle, it is possible to prevent malfunction due to a touch error and reduce an accident due to negligence of forward attention when handling the functions of the vehicle.

In addition, when the 3D map of the region in which the vehicle location information FC8 and the path information FC7 are displayed is moved to and displayed in the first region 140, various driving information (distance, driving time, and fuel efficiency) FC10 may be displayed in the first region.

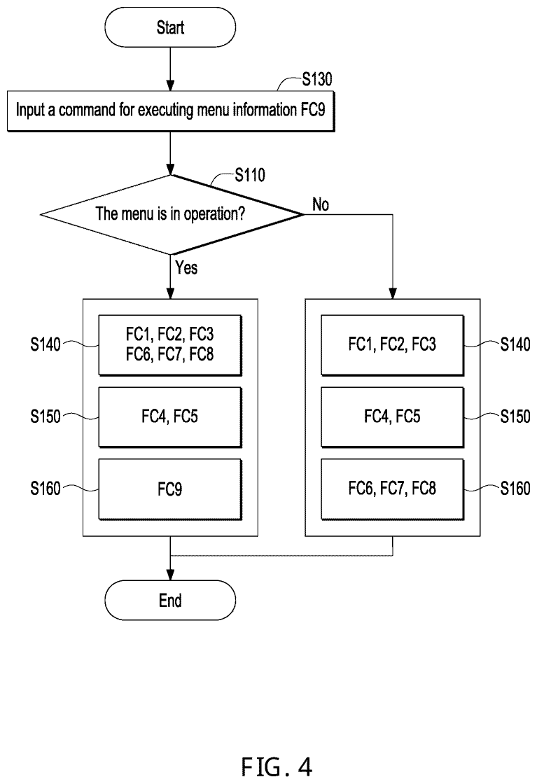

FIG. 4 is a flowchart illustrating a process of displaying a navigation information element in the first region when another information element is displayed on the third region in an in-vehicle infotainment system according to an embodiment of the present disclosure;

Referring to FIG. 4, the in-vehicle infotainment system receives a command for executing menu information FC9 in step S130, which is another screen information element, from a driver through an input unit.

When the command for executing the menu information is input through the input unit 130 (yes in S110), the controller 110 controls the menu to be activated in the third region 160 in step S160 and controls the navigation information element displayed in the third region to be displayed in the first region 140 in step S140, while the information elements FC4 and FC5 being kept displayed in the second region 150 in step S150.

Also, if the command for executing the menu information is not input through the input unit 130 (no in S110), the controller 110 controls to keep the previous displaying configurations, in other words, keep the information elements FC1, FC2 and FC3 to be displayed in the first region 140 in step S140, the information elements FC4 and FC5 to be displayed in the second region 150 in step S150, and the information elements FC6, FC7 and FC8 to be displayed in the third region 160 in step S160.

The embodiment of the present disclosure moves the navigation information to another region of the screen and displays the navigation information even when the other information is displayed on the screen where the navigation information is displayed, thereby solving the problem of the navigation information from disappearing while driving, and further, displaying a manual on the entire screen where the navigation screen is displayed, thereby improving touch operation and visibility.

Although the above description has focused on the embodiments, it will be understood that this is merely illustrative and the present disclosure is not limited thereto, and that various modifications and applications not illustrated above may be made without departing from the essential characteristics of the present disclosure. For example, each feature element shown specifically in the embodiment may be modified and implemented. Further, the differences related to the modifications and applications should be interpreted as being included in the scope of the present disclosure defined in the appended claims.

What is claimed is:

1. An in-vehicle infotainment system of a vehicle, the in-vehicle infotainment system comprising:
a display device comprising a first region, a second region, and a third region;
storage configured to store a first information element, a second information element, and a third information element; and
a controller configured to control the display device to display:
the first information element in the first region,
the second information element in the second region,
the third information element in the third region; and
control, based on an additional information element being displayed in the third region, the display device to display, in the first region, the first information element and the third information element.

2. The in-vehicle infotainment system according to claim 1, wherein the first information element comprises a driving information element associated with the vehicle, wherein the second information element comprises a user-selected information element, and wherein the third information element comprises a navigation information element.

3. The in-vehicle infotainment system according to claim 2, wherein the driving information element indicates at least one of a vehicle speed, an engine speed, or fuel efficiency.

4. The in-vehicle infotainment system according to claim 2, wherein the user-selected information element indicates at least one of a picture, a current date, a current time, or an external temperature.

5. The in-vehicle infotainment system according to claim 2, wherein the navigation information element comprises a navigation map being displayed across the first region, the second region, and the third region.

6. The in-vehicle infotainment system according to claim 5, wherein the navigation information element further comprises a vehicle location information element indicating a current location of the vehicle, and
wherein the controller is further configured to control the display device to display, in the third region and based on the additional information element being displayed in the third region, the navigation map, the vehicle location information element, and path information element.

7. The in-vehicle infotainment system according to claim 1, wherein the additional information element comprises at least one of an application menu, a display setting menu, or a navigation settings menu.

8. The in-vehicle infotainment system according to claim 1, wherein the first region, the second region, and the third region are integrally formed on a screen of the display device.

9. The in-vehicle infotainment system according to claim 1, wherein the controller is further configured to control the display device to display a wide-format screen spanning the first region, the second region, and the third region.

10. The in-vehicle infotainment system according to claim 1, wherein the controller is further configured to control the display device to display a navigation map in a background of the first region, the second region, and the third region, and wherein the third information element comprises an icon indicating a location of the vehicle on the navigation map.

11. A method comprising:
displaying, via a display device of an infotainment system in a vehicle:
a first information element in a first region of the display device,
a second information element in a second region of the display device, and
a third information element in a third region of the display device;
receiving a command for displaying an additional information element in the third region; and
displaying, based on the receiving of the command:
the first information element and the third information element in the first region, and
the additional information element in the third region.

12. The method according to claim 11, wherein the first information element comprises a driving information element associated with the vehicle, wherein the second information element comprises a user-selected information element, and wherein the third information element comprises a navigation information element.

13. The method according to claim 12, wherein the driving information element indicates at least one of a vehicle speed, an engine speed, or fuel efficiency.

14. The method according to claim 12, wherein the user-selected information element indicates at least one of a picture, a current date, a current time, or an external temperature.

15. The method according to claim 12, wherein the navigation information element comprises a navigation map being displayed across the first region, the second region, and the third region.

16. The method according to claim 15, wherein the navigation information element further comprises a vehicle position information element indicating a current location of the vehicle, and
wherein the method further comprises displaying, via the display device and in the third region and based on the additional information element being displayed in the third region, the navigation map, the vehicle position information element, and path information element.

17. The method according to claim 11, wherein the additional information element comprises at least one of an application menu, a display setting menu, and a navigation settings menu.

18. The method according to claim 11, further comprising displaying, via the display device, a wide-format screen spanning the first region, the second region, and the third region,
wherein the wide-format screen extends:
from a left edge of a driver-side compartment to a right edge of a passenger-side compartment, based on the driver-side being a left side of the vehicle, or
from a right edge of the driver-side compartment to a left edge of the passenger-side compartment, based on the driver-side being a right side of the vehicle.

19. The method according to claim 11, further comprising displaying, via the display device, a navigation map in a background of the first region, the second region, and the third region, wherein the third information element comprises an icon indicating a location of the vehicle on the navigation map.
